(19) United States
(12) Patent Application Publication
(10) Pub. No.: US 2024/0385052 A1
(43) Pub. Date: Nov. 21, 2024

(54) TEST SYSTEMS CONFIGURED TO TEST DEVICES AT DIFFERENT TEMPERATURES

(71) Applicant: Teradyne, Inc., North Reading, MA (US)

(72) Inventor: Nathan J. Blosser, Beverly, MA (US)

(21) Appl. No.: 18/197,445

(22) Filed: May 15, 2023

(51) Int. Cl. G01K 1/20; G01K 1/26

(52) U.S. Cl. CPC G01K 1/20; G01K 1/26

(57) ABSTRACT

An example test system includes a plenum including an air inlet and a rack including slots to hold devices under test. The rack is adjacent to the plenum. The slots are arranged on the rack in a matrix such that part of each device held in a slot borders the plenum and is in fluid communication with the air inlet. One or more blowers are configured to force temperature-conditioned air into the air inlet of the plenum to thereby increase air pressure in the plenum and force the temperature-conditioned air over the devices and out of the plenum.

### TECHNICAL FIELD

This specification describes example implementations of test systems configured to test devices at different temperatures.

### BACKGROUND

A test system is configured to test the operation of a device. A device tested by the test system is referred to as a device under test (DUT). The test system may include test instruments to send commands such as signals and data to the DUT for testing. The DUT responds with response data. The test system expects the response data to have certain values. If the response data has those values, the DUT passes testing. If the response data does not have those values, then the DUT may fail testing.

The DUTs are tested for operation at different temperatures. For example, the DUTs may be heated then tested and may be cooled then tested. FIG. 1 shows an example test system 10 in which DUTs 12 are heated or cooled using an air flow that moves in the direction of arrows 14. DUTs at the beginning 15 of the air flow receive air at an appropriate temperature. DUTs that are not at the beginning of the air flow, and particularly DUTs that are at the end 16 of the air flow across the DUTS, receive air that has been heated by DUTs 12 along the path 14a of the air flow. As a result, temperature control of DUTs in such a system may be inconsistent across the various DUTs, which can make testing under different thermal conditions challenging in some cases.

### SUMMARY

An example test system includes a plenum including an air inlet, and a rack including slots to hold devices under test. The rack is adjacent to the plenum. The slots are arranged on the rack in a matrix such that part of each device held in a slot borders the plenum and is in fluid communication with the air inlet. One or more blowers are configured to force temperature-conditioned air into the air inlet of the plenum to thereby increase air pressure in the plenum and force the temperature-conditioned air over the devices and out of the plenum. The example test system may include one or more of the following features, either alone or in combination.

The plenum is a first plenum and the test system may include a second plenum. The slots may be arranged on the rack in the matrix such that part of each device held in a slot also borders the second plenum. The temperature-conditioned air may be forced over the devices into the second plenum.

Each slot may be configured to hold a corresponding device so that there is an air gap in the slot. The air gap may be configured for directing air from the plenum over a surface of the corresponding device. Each slot may be configured to hold the corresponding device so that there are air gaps adjacent to different surfaces of the corresponding device. Each air gap may be configured for directing air from the plenum over a different surface of the corresponding device.

The test system may include a heater to produce temperature-conditioned air that is above room temperature. The test system may include a coolant to produce temperature-conditioned air that is below room temperature. The temperature-conditioned air may be between −40° Celsius (C) and 100° C.

The test system may include test instruments that are external to the plenum, and cables that connect the test instruments to the devices. The test system may include glands that are sealed to the plenum. The cables may pass through the glands.

The glands may include an elastomeric material. In some examples, the test system does not include air movers dedicated to (e.g., inside of or associated with) individual slots.

The rack may have a first side facing the first plenum and a second side facing the second plenum. The test system may include temperature sensors on the first side and/or on the second side. The temperature sensors produce readings indicative of temperature in a region of the DUTs. The temperature sensors may be spaced in a regular pattern across the matrix. The test system may have fewer temperature sensors than there are slots in the test system.

The test system may include a control system to control the one or more blowers based on the readings and/or to control at least one of an air heating system or an air cooling system. The control system may include a proportional-integral-derivative controller. The control system may be configured to obtain temperature readings from the devices. The control system maybe configured to control the one or more blowers based also on the temperature readings from the devices. The control system may also be configured to control at least one of the air heating system or the air cooling system based on the temperature readings from the devices.

The test system may include adapters that fit into the slots. Each adapter may be for holding a corresponding device. The adapters may have different physical and/or electrical configurations to hold different types of devices at a same time within the rack.

The slots may be configured for manual loading and unloading of the devices.

The test system may include robotics to move the devices into and out of the slots.

Each device may be or include a solid state drive. A back of each solid state may face faces the first plenum, and a front of each solid state drive may face the second plenum.

The test system may be, or be part of, a batch tester. The batch tester may be configured for performing thermal testing of the devices as part of a group. In some examples, the batch tester is configured not to perform thermal testing on the devices individually, e.g., not to change the temperature of the devices individually but still to send and receive signals to individual devices for testing.

Any two or more of the features described in this specification, including in this summary section, may be combined to form implementations not specifically described in this specification.

At least part of the devices, systems, and processes described in this specification may be configured or controlled by executing, on one or more processing devices, instructions that are stored on one or more non-transitory machine-readable storage media. Examples of non-transitory machine-readable storage media include read-only memory, an optical disk drive, memory disk drive, and random access memory. At least part of the devices, systems, and processes described in this specification may be configured or controlled using a computing system comprised of one or more processing devices and memory storing instructions that are executable by the one or more processing devices to perform various control operations. The devices, systems, and processes described in this specification may be configured, for example, through design, construction, composition, arrangement, placement, programming, operation, activation, deactivation, and/or control.

The details of one or more implementations are set forth in the accompanying drawings and the following description. Other features and advantages will be apparent from the description and drawings, and from the claims.

### DESCRIPTION OF THE DRAWINGS

FIG. 1 is a block diagram showing components of a prior art test system.

FIG. 2 is a block diagram showing a perspective view of components of an example test system for testing devices at different temperatures.

FIG. 3 is a block diagram showing a top view of components of the example test system of FIG. 2.

FIG. 4 is a block diagram showing a back perspective view of components of the example test system of FIG. 2.

FIG. 5 is a front perspective view of slots in the test system of FIG. 2 and examples of adapters for use in the slots.

FIG. 6 is front perspective view of the test system of FIG. 2.

FIG. 7 is a partially transparent back perspective view of the test system of FIG. 2.

FIG. 8 is a front perspective view of an example test system having multiple racks containing slots for holding devices to test.

Like reference numerals in different figures indicate like elements.

### DETAILED DESCRIPTION

Described herein are example implementations of a test system configured to control the temperature of devices during testing. The test system includes a rack having slots, each of which is configured to hold a device under test (DUT). Examples of types of DUTs that may be held in the slots and tested using the test system include, but are not limited to, storage devices such as solid state drives (SSDs) and hard disk drives, semiconductor devices such as microprocessors, and printed circuit boards (PCBs) containing one or more different types of electronic devices.

The rack is adjacent to a plenum containing temperature-conditioned air. The temperature-conditioned air may be cold air or hot air with, in some examples, cold air being below room temperature (e.g., 20° Celsius (C)) and hot air being above room temperature. In this regard, room temperature may vary and may be the temperature of the testing environment. The slots are arranged in a matrix such that part of each DUT in a slot borders the plenum and is in contact with the temperature-conditioned air in the plenum. For example, in the case of SSDs, the front or back of each SSD may border the plenum. Air from the plenum thus may be used to heat or to cool each SSD.

More specifically, the plenum is at least partially enclosed and includes an air inlet that is in fluid communication with one or more air blowers (“blowers”). The blower(s) are controllable to force heated or cooled air into the plenum. The air pressure in the plenum increases as a result of the introduction of this temperature-conditioned air into the plenum. The increase in air pressure in the plenum forces the temperature-conditioned air over the DUTs, thereby changing the temperature of the DUTs so that the DUTs can be tested at different temperatures.

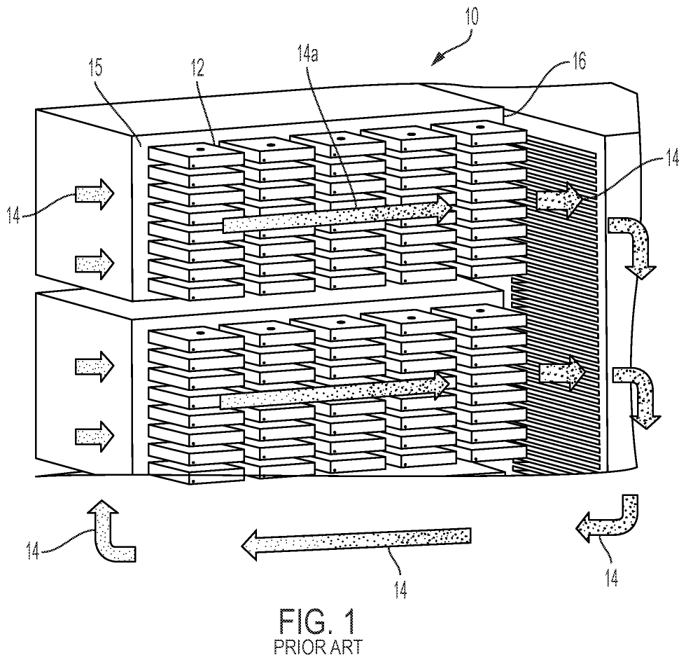

The foregoing example configuration may have advantages. For example, because part of each DUT in a slot borders the plenum, each DUT is in contact with (for example, in direct contact with), and in a flow path of (for example, in a direct flow path of), the temperature-conditioned air in the plenum. Because each DUT receives air (for example, directly) from the plenum, in some examples the temperature control over each DUT may be substantially uniform. That is, the air impacting each DUT may be at substantially the same temperature, enabling substantially consistent temperature control for all the DUTs. This is in contrast to test systems described with respect to FIG. 1, where temperature-conditioned air flows across some DUTs causing the air to heat and thereby change temperature before reaching others of the DUTs.

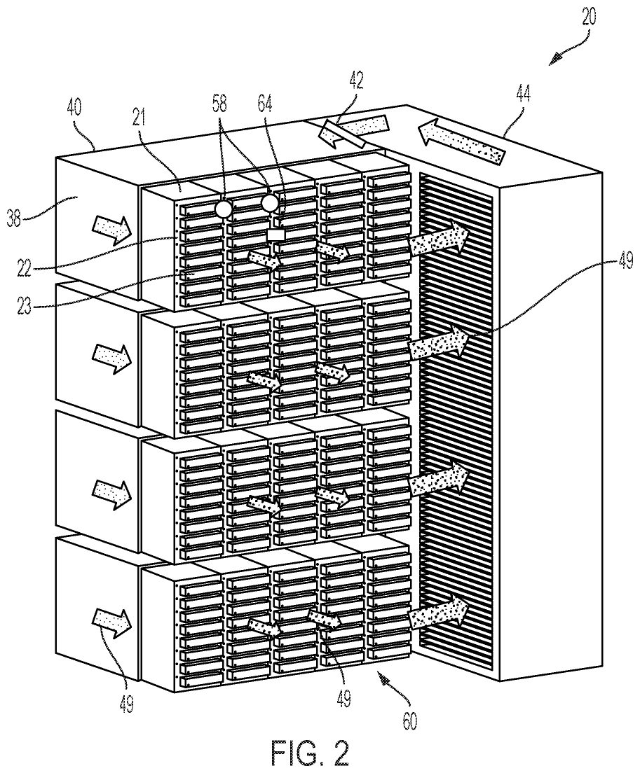

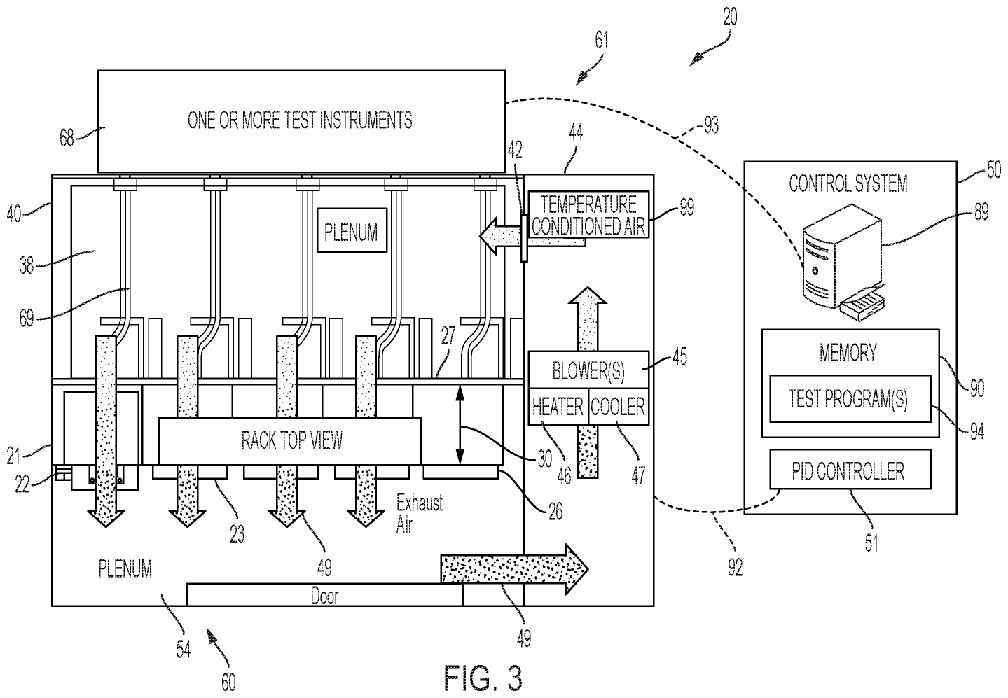

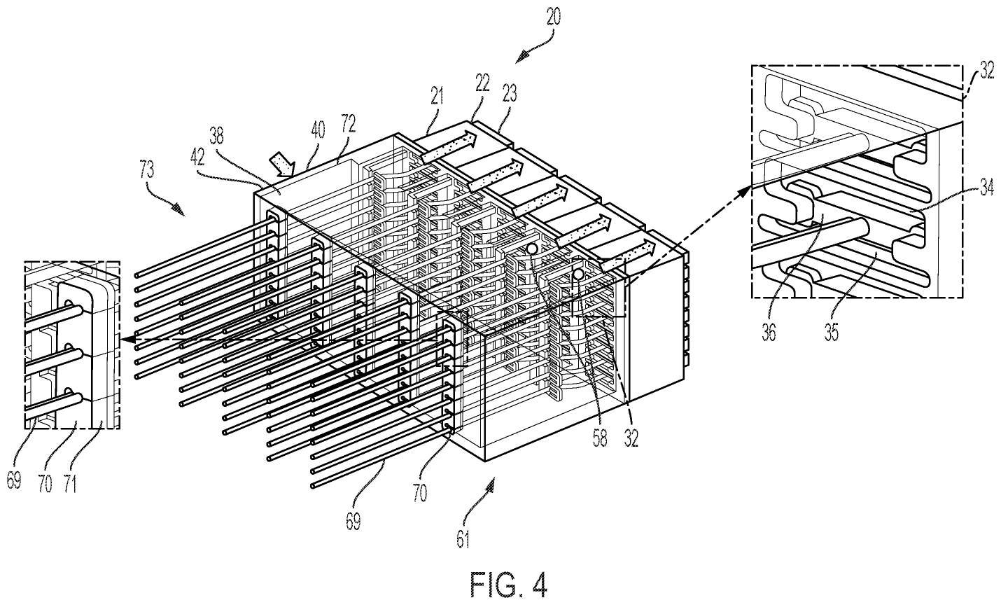

FIG. 2 shows a front perspective view of components of example test system 20 FIG. 3 shows a top view of components of example test system 20; and FIG. 4 shows a back perspective view of components of example test system 20. As shown, in the figures, test system 20 contains a rack 21 that contains slots 22 arranged in a matrix. In the example, the matrix includes multiple columns and multiple rows of slots arranged linearly; however, other slot arrangements may be used. For example, columns and rows of slots may be arranged in a concave or convex semi-circle.

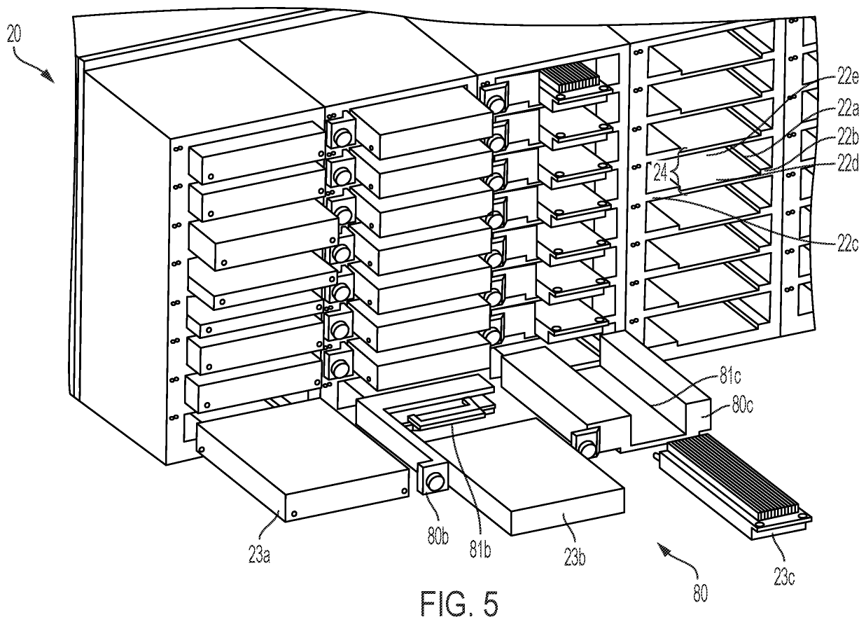

Each slot 22 is configured to hold a DUT 23 throughout a test cycle. An example test cycle includes sending test signals to the DUT and receiving response signals from the DUT over a range of different temperatures. Slots, such as slot 22a of FIG. 5, in the test system may include a ledge or other structure to support a corresponding DUT, such as an SSD. In the example of slot 22a, the ledge includes two parts 22b and 22c. The two parts hold the DUT and suspend the DUT above a floor 22d of the slot, thereby creating an air gap between the floor of the slot a bottom surface of the DUT. The slot and ledges also may be configured to create an air gap between the top surface of the DUT and a ceiling 22e of the slot. For example, a dimension 24 of the slot and a location of the ledge may be selected for a DUT so that there is an air gap between the DUT and the slot ceiling. For example, the dimension 24 of slot 22a between the ledge 22b, 22c and the ceiling 22e may be greater than the corresponding dimension of a DUT that fits within that slot for testing. Accordingly, in some implementations, there are multiple—e.g., two—air gaps adjacent to each DUT in each slot. The slots are open-ended at both ends 26, 27 thereof (FIG. 3); accordingly, the air gaps extend through an entirety of the slot to each end, at least in the dimension of arrows 30. The blown-up part 32 of FIG. 4 shows air gaps 34 and 35 at—for example, adjacent to—the top and bottom surfaces, respectively, of DUT 36 and extending across the entirety of DUT 36.

As shown in FIGS. 2 to 4, in this example, rack 21 borders plenum 38. In this example, plenum 38 includes a region comprised of an enclosure that holds air. Slots 22 are arranged relative to the plenum so that part of each DUT in each slot borders the plenum. In the example of FIGS. 2 to 4, the back of each DUT 23 borders the plenum; however, that need not be the case. For example, the slots may be configured so that the front or a side of each DUT borders the plenum. The plenum holds temperature-conditioned air for controlling temperatures of the DUTs in the slots. Temperature-conditioned air may include cold air or hot air, as explained above. In some implementations, the temperature-conditioned may vary on a continuum between −40° C. and 100° C., although other ranges may be used, such as between −20° C. and 80° C.

Plenum 38 is formed by an enclosure 40. The enclosure may be made of plastic or metal in some implementations. In the example of FIGS. 2 to 4, the enclosure has a rectangular cuboid shape; however, the shape may be different in other examples. For example, the enclosure may be cylindrical or partially spherical in shape in some implementations. In some implementations, the enclosure is air-tight except for a fluidic connection between the plenum and the slots, including the air gaps 34 and 35 in the slots containing DUTs. That is, the air gaps and plenum may be in fluid communication to allow air to flow from the plenum through the air gaps. Enclosure 40 includes an air inlet 42 to receive air from a source, such as one or more blowers.

Referring to FIGS. 2 and 3, air inlet 42 is in fluid communication with temperature conditioner 44. Temperature conditioner 44 may include a housing that houses one or more blowers 45 to direct air from outside the temperature conditioner into the plenum via air inlet 42. The one or more blowers may include two, three, or more blowers. Examples of blowers include air movers, fans, or the like. The temperature conditioner also may include a heater 46 to raise the temperature of air to above room temperature. The heater may include an electrical device having coils that heat in response to applied current. The temperature conditioner may include a cooler 47 to lower the temperature of air to below room temperature. The cooler may include a coolant, e.g., a refrigerant, such as hydrochlorofluorocarbon(s) that runs through thermally-conductive conduits to cool air. A Peltier device may be used both as a heater or a cooler in some examples. The housing of temperature conditioner 44 may be air-tight in some examples except for fluidic connections to plenum 38 and plenum 54 (described below).

As shown in FIGS. 2 and 3, air, referred to as “exhaust” air and represented by arrows 49, from outside of temperature conditioner 44 is suctioned into temperature conditioner 44 by operation of the blowers forcing air in the direction of arrows 49. This outside air is either heated or cooled by the temperature conditioner, depending on the type of testing to be performed in a current test cycle. A control system 50, as described below with respect to FIG. 3, may control operation of the blowers and the heater or cooler based on the type of thermal testing to be performed—e.g., testing at high temperatures or at low temperatures.

In some implementations, control system 50 includes a proportional-integral-derivative (PID) controller 51. An example PID controller includes a feedback controller that continuously calculates an error value as a difference between a setpoint (SP) and a measured process variable (here, temperature) and applies a correction based on proportional, integral, and derivative terms (denoted P, I, and D respectively). In this example, the PID controller receives temperature readings from sensors (described below) associated with rack 21 and/or the DUTs and compares those temperature readings to a target temperature set for thermal testing by a test program. The PID controller then controls the blowers and the heater and/or cooler to operate to reach the target temperature. For example, the PID controller may increase the temperature of the air by controlling heater 46, decrease the temperature of the air by controlling cooler 47, and/or control or speed of movement of the air by controlling blower(s) 45.

The temperature conditioner is configured and controlled to force the temperature-conditioned air into plenum 38. Because the enclosure 40 defining the plenum is at least partially air-tight, the temperature-conditioned air 99 (FIG. 3) forced into the plenum increases the air pressure in the plenum. This increased air pressure forces the temperature-conditioned air out of the plenum 38 via the air gaps 34, 35 (FIG. 4) in the slots 22. The effect of the air moving through the gap(s) adjacent to the DUTs, depending on the temperature of the air, is to cool the DUTs in the slots or to heat the DUTs in the slots. Furthermore, because, in some implementations, there are air gaps above and below the top and bottom surfaces of the DUTs, respectively, the cooling or heating may occur at a relatively rapid rate. In some implementations, there may be an air gap at the top surface of the DUT only or at the bottom surface of the DUT only. In these implementations, heating or cooling will still work using air from the plenum.

In some implementations, the exterior of the rack 21 is enclosed to form a second plenum 54 (FIG. 3), which may or may not be air-tight. Referring to FIG. 6, in some examples, the second plenum 54 is accessible through one or more doors 56 in the front region 60 of the test system. In some implementations, when the door(s) are closed, the combination the first plenum 38, the rack 21, the second plenum 54, and the temperature conditioner 44 form an air-tight or enclosed system. In some implementations, the system is not air-tight.

Referring to FIGS. 2 and 4, in some implementations the system may include temperature sensors 58 in the front region 60 of rack 21, the back region 61, or in both the front region 60 and the back region 61 of rack 21. Only two temperature sensors are shown in FIGS. 2 and 4 for illustration. There may be more than two temperature sensors in the front and back regions as follows. The temperature sensors may be spaced in a regular pattern or in an irregular pattern across the matrix of DUTs. For example, in some implementations, there may be one temperature sensor for each group of four slots 22; in some implementations, there may be one temperature sensor for each group of eight slots 22; and so forth. In some implementations, there may be one temperature sensor per slot. The arrangement of temperature sensors in the front region 60 and the back region 61 may be the same or different. For example, the front region may have one temperature sensor per group of four slots and the back region may have one temperature sensor per group of eight slots, or vice versa, and so forth.

The temperature sensors monitor the temperature at the front and/or back regions and provide that information to the control system. The control system, including the PID controller, uses readings from the temperature sensors to control the blower(s), the heater, and/or the cooler to achieve a target temperature, or to achieve a temperature within an acceptable range of the target temperature, at the DUTs. For example, a temperature within an acceptable range of the target temperature may vary from 1%, 2%, 3%, 4%, or 5%, and so forth from the target temperature.

In some implementations, the control system is configured to obtain temperature readings from the DUTs, e.g., through the connections between the DUTs and the test instruments. The control system, including the PID controller, uses the temperature readings from the DUTs to control the blower(s), the heater, and/or the cooler to achieve a target temperature, or to achieve a temperature within an acceptable range of the target temperature, at the DUTs. For example, as above, a temperature within an acceptable range of the target temperature may vary from 1%, 2%, 3%, 4%, or 5%, and so forth from the target temperature.

In some implementations, the control system may use temperature readings from both the DUTs and the temperature sensors to control the blower(s), the heater, and/or the cooler. For example, temperature readings may not be available from all DUTs in the racks, in which case temperature sensor readings may be used for DUTs not providing temperature readings. In implementations where both temperature sensor readings and temperature readings from the DUTs are available, the control system may give precedence to temperature readings from the DUTs when controlling the blower(s), the heater, and/or the cooler since those temperature readings constitute direct measurements of device temperature.

In some implementations, air movers (e.g., air mover 64, FIG. 2) such as fans may be located in the front region 61 of rack 21 to move air in the direction of arrows 49. For example, the air movers may be spaced in a regular pattern or an irregular pattern across the matrix of DUTs. For example, in some implementations, there may be one air mover for each group of four slots 22; in some implementations, there may be one air mover for each group of eight slots 22; and so forth. In some implementations, individual slots do not contain dedicated air movers; in other words, in such implementations there is not an air mover in an each slot. In some implementations, there may be an individual air mover in each slot. In some implementations, there may be air movers (not shown) in the back region spaced in a manner similar to, or different from, those in the front region to move air in the direction of arrows 49.

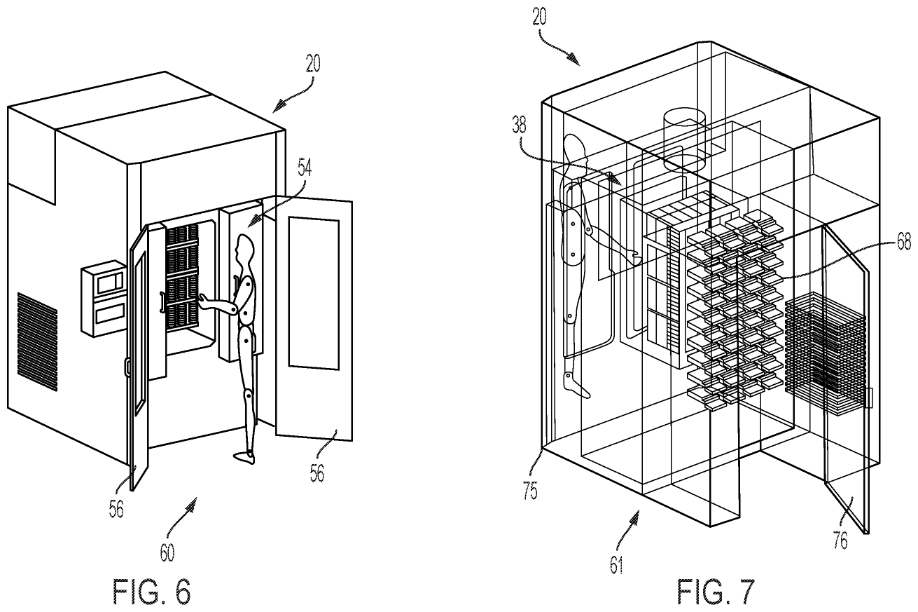

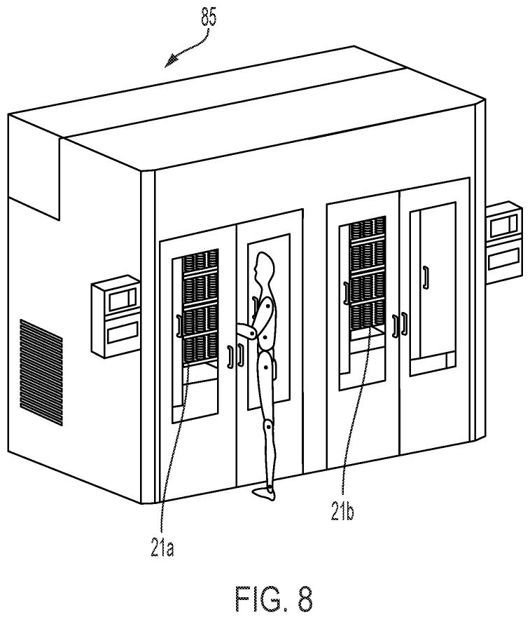

Referring to FIG. 3, one or more test instruments 68 are configured to test the DUTs in rack 21. The test instruments may be hardware devices that may include one or more processing devices and/or other circuitry. The test instruments may be configured—for example, programmed—to output commands to test DUTs held in rack 21. The commands to test the DUTs may be or include instructions, test signals, data, parameters, variables, test patterns, and/or any other information designed to elicit response(s) from the DUT. One or more—for example, all of—the test instruments may be configured to receive, from the DUT, responses to the commands sent from the test instruments to the DUT. The responses are in the form of response data. The test instruments may be configured to analyze the response data to determine whether the DUT has passed or failed testing. As shown in FIG. 7, the test instruments 68 may be within an enclosure 75 around the entirety of the test system 20 and may be accessible by opening one or more doors 76 in the back region of the test system. In this regard, the test instruments may be modular, with the access through door(s) 76 allowing replacement of individual ones of the test instruments.

As shown in FIGS. 3 and 7, in some implementations, the test instruments are not located within the plenum. In other words, the test instruments are exterior to the plenum. For example, as shown in FIG. 3, the test instruments 68 for testing the DUTs in the slots are located outside the plenum. Having the test instruments outside of the plenum may be advantageous in that the test instruments are not subjected to the temperature fluctuations within the plenum. Rather, as shown in FIGS. 3 and 4, cables 69, which pass through plenum 38 to the exterior of the plenum, connect the test instruments 68 to the DUTs 23 held in the slots. The cables 69 may have thermal shielding to reduce the effects of the temperature fluctuations on the cables during heating and cooling cycles in the plenum 38. For example, the thermal shielding may be polyvinyl chloride (PVC) or polyethylene. As shown in FIG. 4, glands 70 may act as the interface between the interior 72 and exterior 73 of the plenum. Each gland may be made of elastomeric material, such as foam or rubber, which creates an air-tight seal to the plenum's enclosure and an air tight seals to the cables through the gland. A close-up view of a gland 70 is shown in blown-up portion 71.

Referring to FIG. 5, in some implementations, the test system may include adapters 80. The adapters may be configured to fit within the test slots and to hold DUTs having sizes that are different, e.g., smaller, than the test slots. Some DUTS may have different electrical and mechanical connectors. The adapters may have complementary electrical and/or mechanical connectors to which such DUTS interface, while still having electrical and/or mechanical connectors that enable the adapters to fit into slots 22 and be used with the test system in the manner described herein. Different types of adapters may hold different types of DUTs. For example, adapter 80b may be configured to hold DUT 23b. In this example, the region 81b within adapter 80b that holds DUT 23b has a complementary shape to DUT 23b and complementary electrical connections to DUT 23b. Adapter 80c may be configured to hold DUT 23c. Again, the region 81c that holds DUT 23c within adapter 80c has a complementary shape to DUT 23c and complementary electrical connections to DUT 23c. The adapters may each be configured to support air gaps above and/or below each DUT to enable air to flow from plenum 38 through rack 21 to heat or to cool the DUT in the adapter. As shown in FIG. 5, the test system may be operated to test different types of DUTs using different, or no, adapters (DUT 23a), concurrently; that is, at the same time.

In some implementations, test system 20 is a batch tester. An example batch tester tests DUTs by group. For example, during testing, the DUTs loaded into rack 21 may be thermally controlled as a group. More specifically, the DUTs may be thermally controlled as a group and then the individual DUTs may be tested by sending commands (e.g., test signals) from the test instruments to the DUTs and analyzing the DUTs responses. This type of testing may occur over a range of temperatures to determine whether the DUTs pass or fail testing. In some implementations, the test system 20 is configured not to provide thermal control over individual DUTs in the rack, e.g., not to provide independent temperature control over individual DUTs.

In some implementations, DUTs may be loaded into the rack manually and removed from the racks manually. In some implementations, a robotic arm (not shown) or other robotics may be used to load DUTs into the rack and to remove the DUTs from the rack. The DUTs may be loaded by opening door(s) 56 (FIG. 6) to access the racks. The doors may be open manually or using appropriate robotics.

Referring to FIG. 8, an example test system 85 of the type described herein may be configured to control the temperatures of DUTs in more than one rack (e.g., two racks or more) 21a and 21b concurrently. That is, each rack 21a and 21b may include slots configured so that the DUTs contained therein are in direct contact with the same, or common, plenum. Air from the common plenum moves over the DUTs in the slots as described herein to heat or to cool the DUTs.

Referring to FIG. 3, control system 50 is configured to—e.g., programmed to—communicate with test instruments 68 to direct and/or to control testing of the DUTs in accordance with one or more test programs. Control system 50 may be configured to control temperature conditioner 44 in accordance with one or more test programs run by the control system. The control system may be or include a computing system comprised of one or more processing devices 89 (e.g., microprocessor(s)) and memory 90 for storage. The control system may communicate with the test instruments and the temperature conditioner over a wired and/or wireless connection(s) 92, 93. In an example, the control system 50 may be configured to execute the test program(s) 94 stored in memory 90 and may include the PID controller to control the blower(s), the heater, and the cooler to set the DUT temperatures to a target temperature specified in the test program(s). The control system may send test routines and/or commands to test instrument(s), which may send the commands, or execute the routines to send commands, to the DUTs in order to test the DUT after the DUTs are at a target temperature. The test instruments receive DUT response signals (e.g., measurement data) from the DUTs in response to the commands, and determine whether DUTs have passed or failed testing based on the measurement data or send the DUT response signals to the control system for analysis. Thereafter, the DUT temperature may be changed as described herein and the process may be repeated. This may occur for a range of temperatures specified by the test program(s).

All or part of the test systems and processes described in this specification and their various modifications may be configured or controlled at least in part by one or more computers such as control system 50 using one or more computer programs tangibly embodied in one or more information carriers, such as in one or more non-transitory machine-readable storage media. A computer program can be written in any form of programming language, including compiled or interpreted languages, and it can be deployed in any form, including as a stand-alone program or as a module, part, subroutine, or other unit suitable for use in a computing environment. A computer program can be deployed to be executed on one computer or on multiple computers at one site or distributed across multiple sites and interconnected by a network.

Actions associated with configuring or controlling the test system and processes described herein can be performed by one or more programmable processors executing one or more computer programs to control or to perform all or some of the operations described herein. All or part of the test systems and processes can be configured or controlled by special purpose logic circuitry, such as, an FPGA (field programmable gate array) and/or an ASIC (application-specific integrated circuit) or embedded microprocessor(s) localized to the instrument hardware.

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, such as magnetic, magneto-optical disks, or optical disks. Non-transitory machine-readable storage media suitable for embodying computer program instructions and data include all forms of non-volatile storage area, including by way of example, semiconductor storage area devices, such as EPROM (erasable programmable read-only memory), EEPROM (electrically erasable programmable read-only memory), and flash storage area devices; magnetic disks, such as internal hard disks or removable disks; magneto-optical disks; and CD-ROM (compact disc read-only memory) and DVD-ROM (digital versatile disc read-only memory).

In the description and claims provided herein, the adjectives “first”, “second”, “third”, and the like do not designate priority or order. Instead, these adjectives are used solely to differentiate the nouns that they modify.

Any mechanical or electrical connection herein may include a direct connection or an indirect connection that includes intervening components.

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

Other implementations not specifically described in this specification are also within the scope of the following claims.

What is claimed is:

1. A test system comprising:
a plenum comprising an air inlet;
a rack comprising slots to hold devices under test, the rack being adjacent to the plenum, and the slots being arranged on the rack in a matrix such that part of each device held in a slot borders the plenum and is in fluid communication with the air inlet; and
one or more blowers to force temperature-conditioned air into the air inlet of the plenum to thereby increase air pressure in the plenum and force the temperature-conditioned air over the devices and out of the plenum.

2. The test system of claim 1, wherein the plenum is a first plenum and the test system comprises a second plenum, the slots being arranged on the rack in the matrix such that part of each device held in a slot also borders the second plenum, the temperature-conditioned air being forced over the devices into the second plenum.

3. The test system of claim 1, wherein each slot is configured to hold a corresponding device so that there is an air gap in the slot, the air gap for directing air from the plenum over a surface of the corresponding device.

4. The test system of claim 3, wherein each slot is configured to hold the corresponding device so that there are air gaps adjacent to different surfaces of the corresponding device, each air gap for directing air from the plenum over a different surface of the corresponding device.

5. The test system of claim 1, further comprising a heater to produce temperature-conditioned air that is above room temperature.

6. The test system of claim 1, further comprising a coolant to produce temperature-conditioned air that is below room temperature.

7. The system of claim 1, wherein the temperature-conditioned air is between −40° Celsius (C) and 100° C.

8. The test system of claim 1, further comprising:
test instruments that are external to the plenum; and
cables that connect the test instruments to the devices.

9. The test system of claim 7, further comprising:
glands that are sealed to the plenum, the cables passing through the glands.

10. The test system of claim 9, wherein the glands comprise an elastomeric material.

11. The test system of claim 1, wherein the test system does not include air movers dedicated to individual slots.

12. The test system of claim 1, wherein the plenum is a first plenum; and
wherein the rack has a first side facing the first plenum and a second side facing a second plenum;
wherein the test system further comprises:
temperature sensors on the first side and the second side, the temperature sensors producing readings; and
a control system to control the one or more blowers based on the readings and to control at least one of an air heating system or an air cooling system.

13. The test system of claim 12, wherein the control system comprises a proportional-integral-derivative controller.

14. The test system of claim 13, wherein the temperature sensors are spaced in a regular pattern across the matrix.

15. The test system of claim 14, wherein the test system comprises fewer temperature sensors than there are slots in the test system.

16. The test system of claim 12, wherein the control system is configured to obtain temperature readings from the devices; and
wherein the control system is configured to control the one or more blowers based also on the temperature readings from the devices, the control system also being configured to control at least one of an air heating system or an air cooling system.

17. The test system of claim 1, further comprising:
adapters that fit into the slots, each adapter for holding a corresponding device.

18. The test system of claim 1, wherein the adapters have different physical configurations to hold different types of devices at a same time within the rack.

19. The test system of claim 1, wherein the slots are configured for manual loading and unloading of the devices.

20. The test system of claim 1, further comprising:
robotics to move the devices into and out of the slots.

21. The test system of claim 1, wherein the plenum is a first plenum; and
wherein each device comprises a solid state drive, a back of each solid state drive faces the first plenum, and a front of each solid state drive faces a second plenum.

22. The test system of claim 1, wherein the test system is a batch tester, the batch tester for performing thermal testing of the devices as part of a group.

23. The test system of claim 1, wherein the batch tester is configured not to perform thermal testing on the devices individually.

24. An adapter configured to fit within a slot of a test system configured to hold a device under test (DUT), the adapter comprising:
a connector that is complementary to a connector of the DUT; and
a structure having a shape that is configured to fit within the slot and that is complementary to a shape of the DUT, the adapter being configured to fit within the slot so as to produce an air gap above or below the adapter.

25. The adapter of claim 24, wherein the connector comprises an electrical connector.

26. The adapter of claim 24, wherein the connector comprises a mechanical connector.

27. The adapter of claim 24, wherein the adapter is configured to fit within the slot so as to produce an air gap above the adapter between the slot and the adapter and an air gap below the adapter between the slot and the adapter.
